(19) United States
(12) Patent Application Publication
(10) Pub. No.: US 2012/0213971 A1
(43) Pub. Date: Aug. 23, 2012

(54) METHOD FOR PRODUCING DIE, AND DIE

(75) Inventor: Ichiroh Ihara, Osaka-shi (JP)

(73) Assignee: SHARP KABUSHIKI KAISHA, Osaka-shi, Osaka (JP)

(21) Appl. No.: 13/504,551

(22) PCT Filed: Nov. 4, 2010
(86) PCT No.: PCT/JP2010/069625

§ 371 Date: Apr. 27, 2012

(30) Foreign Application Priority Data
Nov. 6, 2009 (JP) 2009-255534

(51) Int. Cl. B32B 3/30; C25D 5/48; B29C 33/56

(52) U.S. Cl. 428/156; 249/114.1; 205/223

(57) ABSTRACT

A mold manufacturing method includes providing an aluminum base or an aluminum film; allowing passage of an electric current between a surface of the aluminum base and a counter electrode in an aqueous solution with the surface being a cathode, thereby forming a plurality of first recessed portions whose two-dimensional size viewed in a direction normal to the surface is not less than 200 nm and not more than 100 μm; thereafter, the step of anodizing the surface, thereby forming a porous alumina layer which has a plurality of second recessed portions whose two-dimensional size is not less than 10 nm and less than 500 nm over an inner surface of the plurality of first recessed portions and between the plurality of first recessed portions; and thereafter, bringing the porous alumina layer into contact with an etchant, thereby enlarging the plurality of second recessed portions of the porous alumina layer.

### TECHNICAL FIELD

The present invention relates to a method for manufacturing a mold and a mold. In this specification, the “mold” includes molds that are for use in various processing methods (stamping and casting), and is sometimes referred to as a stamper. The mold can also be used for printing (including nanoimprinting).

### BACKGROUND ART

Display devices for use in TVs, cell phones, etc., and optical elements, such as camera lenses, etc., usually adopt an antireflection technique in order to reduce the surface reflection and increase the amount of light transmitted therethrough. This is because, when light is transmitted through the interface between media of different refractive indices, e.g., when light is incident on the interface between air and glass, the amount of transmitted light decreases due to, for example, Fresnel reflection, thus deteriorating the visibility.

An antireflection technique which has been receiving attention in recent years is forming over a substrate surface a very small uneven pattern in which the interval of recessed portions or raised portions is not more than the wavelength of visible light (λ=380 nm to 780 nm). See Patent Documents 1 to 4. The two-dimensional size (typically, diameter) of a raised portion of an uneven pattern which performs an antireflection function is not less than 10 nm and less than 500 nm.

This method utilizes the principles of a so-called moth-eye structure. The refractive index for light that is incident on the substrate is continuously changed along the depth direction of the recessed portions or raised portions, from the refractive index of a medium on which the light is incident to the refractive index of the substrate, whereby reflection of a wavelength band that is subject to antireflection is prevented.

The moth-eye structure is advantageous in that it is capable of performing an antireflection function with small incident angle dependence over a wide wavelength band, as well as that it is applicable to a number of materials, and that an uneven pattern can be directly formed in a substrate. As such, a high-performance antireflection film (or antireflection surface) can be provided at a low cost.

As the method for forming a moth-eye structure, using an anodized porous alumina layer which is obtained by means of anodization (or “anodic oxidation”) of aluminum has been receiving attention (Patent Documents 2 to 4).

Now, the anodized porous alumina layer which is obtained by means of anodization of aluminum is briefly described. Conventionally, a method for forming a porous structure by means of anodization has been receiving attention as a simple method for making nanometer-scale micropores (very small recessed portions) in the shape of a circular column in a regular arrangement. An aluminum base is immersed in an acidic electrolytic solution of sulfuric acid, oxalic acid, phosphoric acid, or the like, or an alkaline electrolytic solution, and this is used as an anode in application of a voltage, which causes oxidation and dissolution. The oxidation and the dissolution concurrently advance over a surface of the aluminum base to form an oxide film which has micropores over its surface. The micropores, which are in the shape of a circular column, are oriented vertical to the oxide film and exhibit a self-organized regularity under certain conditions (voltage, electrolyte type, temperature, etc.). Thus, this anodized porous alumina layer is expected to be applied to a wide variety of functional materials.

A porous alumina layer manufactured under specific conditions includes cells in the shape of a generally regular hexagon which are in a closest packed two-dimensional arrangement when seen in a direction perpendicular to the film surface. Each of the cells has a micropore at its center. The arrangement of the micropores is periodic. The cells are formed as a result of local dissolution and growth of a coating. The dissolution and growth of the coating concurrently advance at the bottom of the micropores which is referred to as a barrier layer. As known, the size of the cells, i.e., the interval between adjacent micropores (the distance between the centers), is approximately twice the thickness of the barrier layer, and is approximately proportional to the voltage that is applied during the anodization. It is also known that the diameter of the micropores depends on the type, concentration, temperature, etc., of the electrolytic solution but is, usually, about ⅓ of the size of the cells (the length of the longest diagonal of the cell when seen in a direction vertical to the film surface). Such micropores of the porous alumina may constitute an arrangement which has a high regularity (periodicity) under specific conditions, an arrangement with a regularity degraded to some extent depending on the conditions, or an irregular (non-periodic) arrangement.

Patent Document 2 discloses a method for producing an antireflection film (antireflection surface) with the use of a stamper which has an anodized porous alumina film over its surface.

Patent Document 3 discloses the technique of forming tapered recesses with continuously changing pore diameters by repeating anodization of aluminum and a pore diameter increasing process.

The present applicant discloses in Patent Document 4 the technique of forming an antireflection film with the use of an alumina layer in which very small recessed portions have stepped side surfaces.

As described in Patent Documents 1, 2, and 4, by providing an uneven structure (macro structure) which is greater than a moth-eye structure (micro structure) in addition to the moth-eye structure, the antireflection film (antireflection surface) can be provided with an antiglare function. The two-dimensional size of a raised portion of the uneven structure which is capable of performing the antiglare function (which is also referred to as “antiglare structure”) is not less than 1 μm and less than 100 μm. The entire disclosures of Patent Documents 1, 2, and 4 are herein incorporated by reference.

Utilizing such an anodized porous aluminum film can facilitate the manufacturing of a mold which is used for formation of a moth-eye structure over a surface (hereinafter, “moth-eye mold”). In particular, as described in Patent Documents 2 and 4, when the surface of the anodized aluminum film as formed is used as a mold without any modification, a large effect of reducing the manufacturing cost is achieved. The structure of the surface of a moth-eye mold which is capable of forming a moth-eye structure is herein referred to as “inverted moth-eye structure”.

Patent Document 5 describes forming a plurality of recesses in a smooth surface of an aluminum plate before anodization of the aluminum plate such that the arrangement and interval of the recesses are identical with those of micropores of an alumina film formed by anodization. In this way, a porous alumina layer is formed which has regularly-arranged micropores (minute recessed portions) of a predetermined shape such that the interval and arrangement of the micropores are identical with those of the plurality of recesses formed before the anodization. Patent Document 5 also discloses that, to obtain micropores of higher straightness, verticality, and independency, it is desired that the surface of the aluminum plate has improved smoothness.

### CITATION LIST

### Patent Literature

Patent Document 1: Japanese PCT National Phase Laid-Open Publication No. 2001-517319
Patent Document 2: Japanese PCT National Phase Laid-Open Publication No. 2003-531962
Patent Document 3: Japanese Laid-Open Patent Publication
No. 2005-156695
Patent Document 4: WO 2006/059686
Patent Document 5: Japanese Laid-Open Patent Publication No. 10-121292

### SUMMARY OF INVENTION

### Technical Problem

The present inventor attempted to manufacture a moth-eye mold using an aluminum base which has a mirror-finished surface produced by cutting (hereinafter, simply referred to as “mirror-cut surface”) but obtained only a porous alumina layer which has minute recessed portions in a nonuniform distribution. An example of the experimental result is described below.

As shown in FIG. 8(a), an aluminum base which had a mirror-cut surface (curved surface) was provided. This resultant aluminum base was anodized, and a striped pattern such as shown in FIG. 8(b) was observed by a human eye. Observing this surface by SEM, it was found that the formation density of the minute recessed portions was low and that the distribution of the minute recessed portions was nonuniform as shown in FIG. 8(c). The minute recessed portions were present in higher densities in regions which appear as white stripes in FIG. 8(b). The white stripes formed were parallel to the directions of a bit which traveled across the aluminum base surface in a cutting process for mirror finishing.

Thus, anodizing a surface of the aluminum base in which a mechanically damaged layer (hereinafter, simply referred to as “damaged layer”) has been formed by machining disadvantageously leads to nonuniform formation of minute recessed portions (nonuniform two-dimensional distribution of minute recessed portions).

Forming a porous alumina layer in a machined surface is important for, for example, manufacturing of a mold in the form of a roll which is capable of uninterrupted performance of the transfer step.

In order to manufacture a mold that is capable of forming an antireflection film (antireflection surface) which has an antiglare function, according to the prior art, an uneven structure for formation of an antiglare structure is formed using a mechanical method, such as a sand blast method, or a chemical etching method before an inverted moth-eye structure is formed as described in Patent Document 1, for example.

The applicant of the present application also discloses, in WO 2009/147858, a method for manufacturing mold which has an uneven structure for formation of an antiglare structure with the use of an aluminum base which contains an impurity element (e.g., Mn, Mg and/or Fe) by utilization of abnormal dissolution which occurs in a portion where the impurity element is segregated.

However, the above prior art method has a problem of poor mold manufacturing efficiency. The method described in the above application is only applicable to an aluminum base which contains an impurity element and has a difficulty in controlling abnormal dissolution with high reproducibility.

The present invention was conceived for the purpose of solving the above problems. One of the major objects of the present invention is to provide an anodized layer formation method that enables formation of a porous alumina layer which has minute recessed portions uniformly distributed in a machined surface of an aluminum base.

Another object of the present invention is to provide a mold manufacturing method that enables efficient manufacture of a mold which has a macro uneven structure that provides an antiglare function and, particularly, a moth-eye mold which has a macro uneven structure that provides an antiglare function.

The present invention is capable of accomplishing at least one of the above objects.

### Solution to Problem

An anodized layer formation method of the present invention includes the steps of: (a) providing an aluminum base which has a machined surface; (b) allowing passage of an electric current between the surface of the aluminum base and a counter electrode, with the surface of the aluminum base being a cathode, in an aqueous solution; and (c) after step (b), anodizing the surface of the aluminum base, thereby forming a porous alumina layer. The passage of an electric current in step (b) is sometimes referred to as “cathode electrolysis”. By performing the cathode electrolysis, a minute uneven structure can be formed over the surface of the aluminum base, an average neighboring distance of the minute uneven structure being smaller than the average neighboring distance of a plurality of minute recessed portions of an intended porous alumina layer. Note that, even when the cathode electrolysis is performed on an aluminum base which does not have a damaged layer or an aluminum film, the same structure can be obtained according to the principle.

In one embodiment, the machined surface is a mirror-finished surface.

In one embodiment, the aluminum base is in the form of a roll.

An inventive method for manufacturing a mold which has an inverted moth-eye structure in its surface includes the step of forming a porous alumina layer according to any of the above anodized layer formation methods, the porous alumina layer having a plurality of minute recessed portions whose two-dimensional size viewed in a direction normal to the surface is not less than 10 nm and less than 500 nm. The average neighboring distance of the plurality of minute recessed portions may be considered as being equal to the two-dimensional size. When viewed in a direction normal to the surface, the plurality of minute recessed portions are generally circular, and the two-dimensional size may be considered as the diameter.

A mold of the present invention includes: an aluminum base which has a mechanically damaged layer; and a porous alumina layer formed on the mechanically damaged layer. Particularly, the porous alumina layer has an inverted moth-eye structure which is preferably used in formation of an antireflection structure.

Another mold manufacturing method of the present invention includes the steps of: (a) providing an aluminum base or an aluminum film; (b) allowing passage of an electric current between a surface of the aluminum base or the aluminum film and a counter electrode in an aqueous solution with the surface being a cathode, thereby forming a plurality of first recessed portions whose two-dimensional size viewed in a direction normal to the surface is not less than 200 nm and not more than 100 μm; (c) after step (b), anodizing the surface, thereby forming a porous alumina layer which has a plurality of second recessed portions whose two-dimensional size viewed in a direction normal to the surface is not less than 10 nm and less than 500 nm over an inner surface of the plurality of first recessed portions and between the plurality of first recessed portions; and (d) after step (c), bringing the porous alumina layer into contact with an etchant, thereby enlarging the plurality of second recessed portions of the porous alumina layer. Note that the two-dimensional size of the second recessed portions formed in step (c) is smaller than the two-dimensional size of the first recessed portions.

In one embodiment, step (a) includes providing an aluminum base which has a machined surface, and step (b) includes allowing passage of an electric current between the machined surface and the counter electrode with the machined surface being a cathode.

In one embodiment, the aluminum base is in the form of a roll.

In one embodiment, an average neighboring distance of the plurality of first recessed portions is not less than 0.5 μm and not more than 100 μm. The average neighboring distance of the plurality of first recessed portions is greater than the average two-dimensional size of the plurality of first recessed portions.

A mold of the present invention is characterized in that it is manufactured according to any of the above-described manufacturing methods.

An antireflection film of the present invention is characterized in that it is produced using the above-described mold.

### Advantageous Effects of Invention

According to the present invention, a porous alumina layer which has uniformly-distributed minute recessed portions can be formed over a machined surface of an aluminum base. Therefore, a porous alumina layer which has uniformly-distributed minute recessed portions can be formed over a perimeter surface of a base that is in the form of a roll. It is possible to manufacture a mold which has an inverted moth-eye structure in its surface using an anodized layer formation method of the present invention.

According to the present invention, a mold which has a macro uneven structure that provides an antiglare function and, particularly, a moth-eye mold which has a macro uneven structure that provides an antiglare function can be efficiently manufactured.

A moth-eye mold of the present invention is suitably used in formation of an antireflection film and an antireflection surface (which are generically referred to as “antireflection structure”).

### BRIEF DESCRIPTION OF DRAWINGS

FIG. 1 (a) is a schematic cross-sectional view of an aluminum base 18 which has a damaged layer 18a. (b) is a schematic cross-sectional view of an aluminum base 18 where a porous alumina layer 10 is formed on a damaged layer 18a. (c) is a schematic cross-sectional view of an aluminum base 18 where a porous alumina layer 10 is formed after removal of a damaged layer 18a.

FIGS. 2 (a) to (f) are schematic cross-sectional views for illustrating an anodized layer formation method of an embodiment of the present invention.

FIG. 3 A schematic diagram for illustrating the principle of cathode electrolysis which is used in an anodized layer formation method of an embodiment of the present invention.

FIG. 4 A photographic image showing a surface of a porous alumina layer which was formed over a mirror-cut surface of an aluminum base according to an anodized layer formation method of an embodiment of the present invention.

FIG. 5 (a) is a SEM image of a mirror-cut surface of an aluminum base on which cathode electrolysis was performed. (b) is a SEM image of the surface on which was anodization was further performed (inventive example).

FIG. 6 (a) is a SEM image of a mirror-cut surface of an aluminum base. (b) is a SEM image of a mirror-cut surface of an aluminum base which was obtained after anodization, without performing cathode electrolysis on the mirror-cut surface (comparative example).

FIG. 7 A graph which illustrates the effect of cathode electrolysis on anodization, showing the variation of a current over time during anodization with a constant voltage.

FIG. 8(a) is a photographic image of a mirror-cut surface of an aluminum base. (b) is a photographic image of the surface obtained after anodization was performed on the aluminum base shown in (a). (c) is a SEM image of the surface shown in (b).

FIG. 9 A graph which illustrates the mechanism of formation of a porous alumina layer, showing the variation of a current over time during anodization with a constant voltage.

FIGS. 10 (a) to (d) are schematic cross-sectional views for illustrating the mechanism of formation of a porous alumina layer.

FIGS. 11 (a) to (c) are schematic cross-sectional views for illustrating a method for manufacturing a mold of an embodiment of the present invention.

FIG. 12 (a) is a SEM image of a surface of a mold of an embodiment of the present invention. (b) is a SEM image of a cross section of an antireflection film which is produced using the mold.

### DESCRIPTION OF EMBODIMENTS

Hereinafter, an anodized layer formation method, a mold manufacturing method, and a mold according to embodiments of the present invention are described with reference to the drawings. Note that the present invention is not limited to illustrated embodiments.

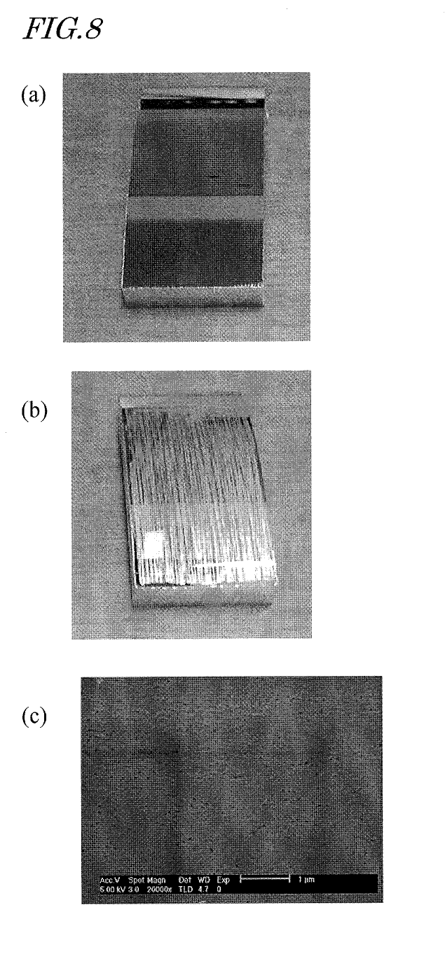

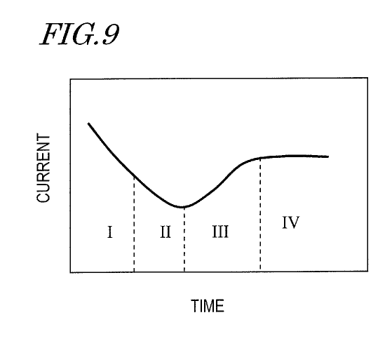

The present invention was conceived for solving a new problem found by the present inventor that, as previously described with reference to FIG. 8, anodizing a surface of an aluminum base which has a damaged layer formed by machining leads to nonuniform formation of minute recessed portions.

As well known in the fields of metalworking, the damaged layer refers to a surface layer whose material properties are changed by working (herein, machining). The damaged layer is estimated to be formed due to irregularity or increase of lattice defects by plastic deformation, or deformation, size reduction or surface flow of crystal grains. Since the damaged layer has a residual strain (residual stress), the presence of a damaged layer and the magnitude of the residual strain can be detected by strain measurement with utilization of X-ray diffraction. In general, it is commonly known that the depth of the damaged layer formed by cutting is about 400 μm at the maximum (for example, Hidehiko TAKEYAMA, University Lectures—Cutting, p. 132, (H7), Maruzen Company, Limited).

The causes of failure to uniformly form minute recessed and raised portions in anodization of a mirror-cut surface and the mechanism by which the above problems are solved according to an anodized layer formation method of the present invention are described hereinbelow. Note that the description provided below is merely a study which is based on the fact experimentally confirmed by the present inventor and is provided as an aid for understanding the present invention. It is not intended to limit the present invention to the description provided below.

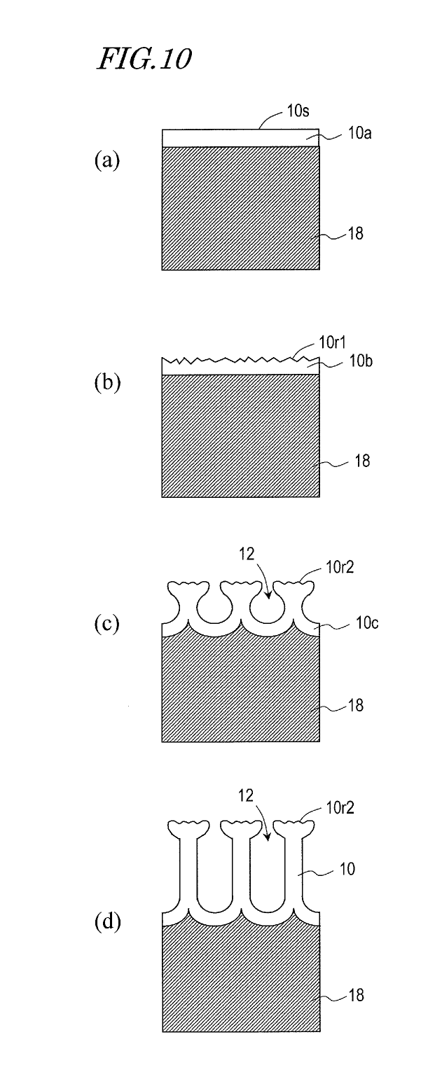

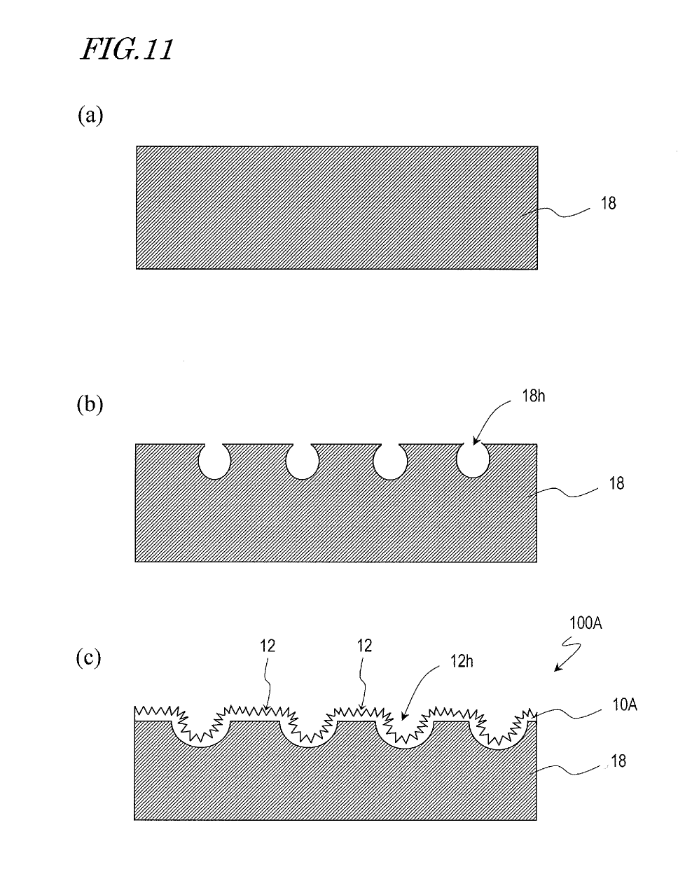

First, the mechanism of formation of a porous alumina layer by anodization of aluminum is described with reference to FIG. 9 and FIG. 10.

FIG. 9 is a graph for illustrating the mechanism of formation of a porous alumina layer. This graph shows the variation of a current over time during anodization with a constant voltage. FIGS. 10(a) to 10(d) are schematic cross-sectional views for illustrating the mechanism of formation of a porous alumina layer. FIG. 10(a), FIG. 10(b), FIG. 10(c) and FIG. 10(d) schematically show the progress of anodization, respectively corresponding to the four modes I, II, III and IV of FIG. 9.

When a surface of an aluminum base is anodized in an electrolytic solution with a constant voltage, the current varies as shown in FIG. 9. According to this current variation profile, the anodization can be separated into the four modes I, II, III and IV. The respective modes are described with reference to FIG. 10(a), FIG. 10(b), FIG. 10(c) and FIG. 10(d).

Mode I (FIG. 10(a)): An anodized alumina layer 10a (sometimes simply referred to as “film”) formed over a surface of an aluminum base 18 is very thin, so that there is an anodic field in the film 10a and at the interface between the film 10a and the electrolytic solution. Since the electric field is intense, the concentration of anion A^{m-} at the interface does not substantially depend on the pH of the solution, and the dissolution rate would not vary depending on the pH. Thus, substantially the same reaction occurs irrespective of the type of the electrolytic solution. Here, a surface 10s of the film 10a is flat.

Mode II (FIG. 10(b)): As the thickness of a film 10b increases, a surface 10r1 of the film 10b becomes slightly rough. Thus, the surface 10r1 has minute recessed and raised portions. Due to these recessed and raised portions, the distribution of the current density becomes nonuniform, leading to local dissolution.

Mode III (FIG. 10(c)): Part of the roughness (recessed and raised portions) produced in the surface 10r1 in Mode II grow to form minute recessed portions 12. The metal/film interface (the interface between the aluminum base 18 and an anodized alumina layer 10c) is deformed into the shape of a bowl, so that the area of local dissolution increases. As a result, the total apparent current increases. The dissolution is restricted within the bottoms of the recessed portions 12 at which the electric field density is strongest.

Mode IV (FIG. 10(d)): The recessed portions (micropores) 12 stably grow.

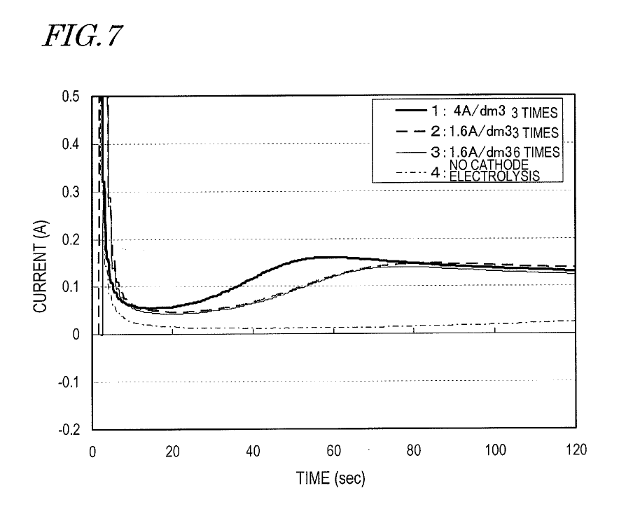

The current profile obtained when the mirror-cut surface is anodized fell within a short period of time and, thereafter, did not substantially vary, as shown by the curve of Condition 4 in FIG. 7 (i.e., anodization in a 0.1 M oxalic aqueous solution with a constant voltage of 60 V). Thus, the current profile has no parts corresponding to Modes III and IV, from which it is inferred that minute recessed portions (micropores) 12 did not formed. The cause of this failure is estimated that there is a damaged layer formed in the mirror-cut surface (mirror-finished surface), and the presence of this damaged layer disturbed production of surface roughness to a degree such that a nonuniform current density distribution occurs in Mode II.

It is estimated that the process of producing roughness in Mode II involves chemical dissolution. Although a porous alumina layer which is used as a moth-eye mold suitable to formation of an antireflection structure has a critical problem that sufficient roughness is not obtained in Mode II because the electrolytic solution used has relatively low chemical dissolution power, the same tendency occurs irrespective of the conditions of anodization (e.g., including the chemical dissolution power of the electrolytic solution).

The machining process described in the above example is a mirror-finishing process by means of cutting. However, the present invention is not limited to that example. The above description applies to other mirror-finishing processes, such as mirror polishing, mirror grinding, etc. The above description also applies to common machining processes to form a damaged layer.

The present invention was conceived based on the above-described knowledge that was found by the present inventor. An anodized layer formation method of an embodiment of the present invention includes the step of forming a minute uneven structure of recessed and raised portions on a machined surface such that the minute uneven structure has a smaller neighboring distance than a plurality of minute recessed portions 12 of an intended porous alumina layer (see the surface 10r1 of FIG. 10(b) and the surface 10r2 of FIG. 10(c)).

The minute uneven structure may be formed by allowing passage of an electric current between a surface of an aluminum base and a counter electrode in an aqueous solution, with the surface of the aluminum base being a cathode (cathode electrolysis).

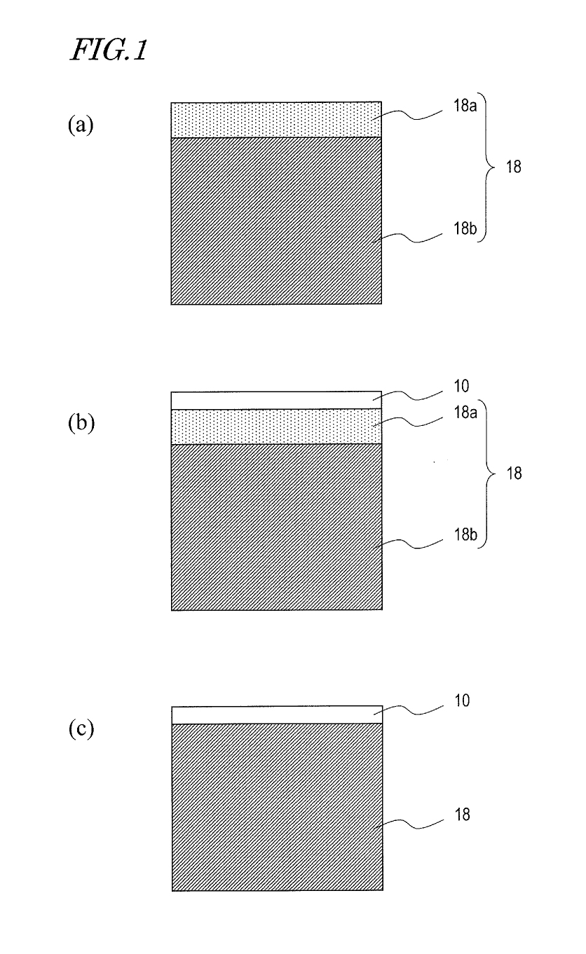

As will be described later with an inventive example, according to an anodized layer formation method of an embodiment of the present invention, a porous alumina layer which has uniformly-distributed minute recessed portions can be formed using the aluminum base 18 that includes a main base body 18b and a damaged layer 18a formed over a surface of the main base body 18b, which is the surface layer of the aluminum base 18, as shown in FIG. 1(a). Thus, using an anodized layer formation method of an embodiment of the present invention enables manufacturing of a mold which has an inverted moth-eye structure in a mirror-finished surface of an aluminum base. A mold that has a porous alumina layer in a mirror-finished surface, which has a plurality of minute recessed portions whose two-dimensional size viewed in a direction normal to the surface is not less than 10 nm and less than 500 nm, is suitably used in formation of a clear-type antireflection structure. Note that the clear-type antireflection structure refers to an antireflection structure which does not have an antiglare function.

According to an anodized layer formation method of an embodiment of the present invention, a porous alumina layer 10 can be formed on the damaged layer 18a of the aluminum base 18 as shown in FIG. 1(b). Also, as shown in FIG. 1(c), a porous alumina layer 10 can be formed after removal of the damaged layer 18a from the aluminum base 18 shown in FIG. 1(a). The base of FIG. 1(b) and the base of FIG. 1(c), on which the porous alumina layer 10 is formed, each can be used as a moth-eye mold without any modification.

Therefore, by providing a base in the form of a roll as the aluminum base 18 shown in FIGS. 1(a) to 1(c), a moth-eye mold can be manufactured which has minute recessed portions uniformly formed in a mirror-finished perimeter surface.

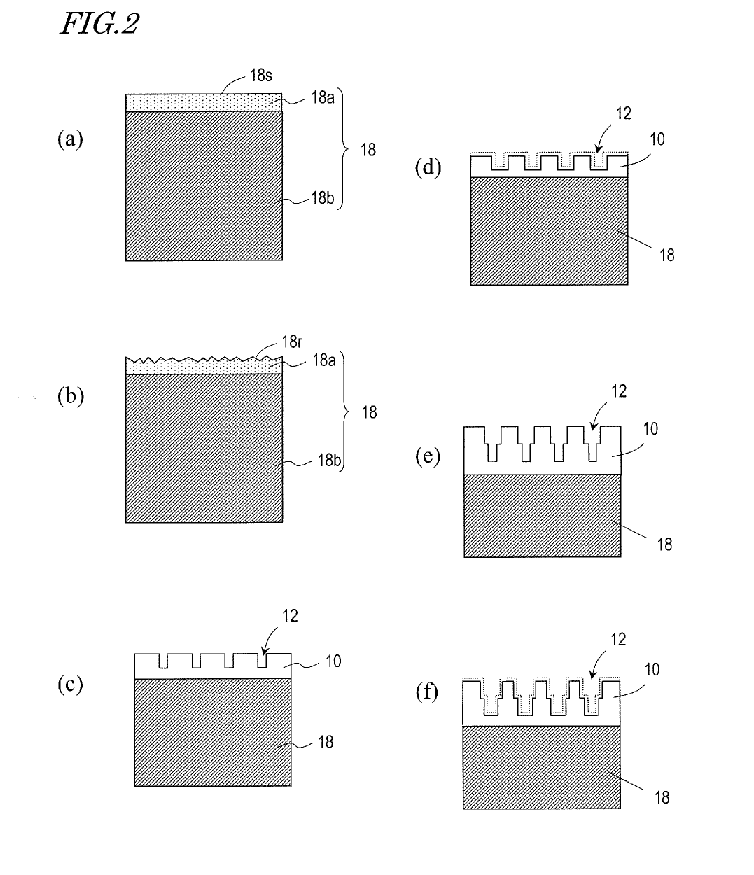

Hereinafter, the anodized layer formation method of the embodiment of the present invention is described in more detail with reference to FIG. 2 to FIG. 7.

FIGS. 2(a) to 2(f) are schematic cross-sectional views for illustrating the anodized layer formation method of the embodiment of the present invention.

First, as shown in FIG. 2(a), an aluminum base 18 which has a machined surface is provided. For example, an aluminum base 18 which has a mirror-cut surface is provided as shown in FIG. 8(a). The aluminum base 18 includes a main body 18b and a damaged layer 18a. A surface 18s of the damaged layer 18a is a mirror-finished surface.

Then, as shown in FIG. 2(b), a minute uneven structure is formed in the surface 18s of the damaged layer 18a by means of cathode electrolysis. Details of the cathode electrolysis will be described later. The minute uneven structure formed in the surface 18r of the damaged layer 18a enables transition of the anodization process to Mode III (see FIG. 9 and FIG. 10). The minute uneven structure formed in a surface 18r has an average neighboring distance which is smaller than the average neighboring distance of a plurality of minute recessed portions of an intended porous alumina layer.

Subsequently, as described in, for example, Patent Document 4, an anodization step and an etching step are alternately repeated multiple times, whereby a porous alumina layer which has minute recessed portions can be formed such that each of the minute recessed portions has a desired cross-sectional shape. For example, a porous alumina layer which is suitably used in formation of an antireflection structure can be formed as described below.

As shown in FIG. 2(c), anodization of the surface 18r of the aluminum base 18 leads to formation of a porous alumina layer 10 which has uniformly-distributed minute recessed portions 12. Thus, since the surface 18r of the damaged layer 18a has the minute uneven structure, the anodization process transitions to Mode III and Mode IV without stoppage at Mode II. The anodization is realized by, for example, applying a voltage of 60 V for 40 seconds in a 0.1 M oxalic aqueous solution. Note that, although not shown, the aluminum base 18 shown in FIGS. 2(c) to 2(f) has the damaged layer 18a on the porous alumina layer 10 side.

Then, as shown in FIG. 2(d), the porous alumina layer 10 that has the minute recessed portions 12 is brought into contact with an etchant such that a predetermined amount is etched away. By the etching, the pore diameter of the minute recessed portions 12 is increased. Here, wet etching may be employed, such that the minute recessed portions 12 can be isotropically enlarged. By adjusting the type and concentration of the etchant and the etching duration, the etching amount (i.e., the size and depth of the minute recessed portions 12) can be controlled. The etchant used herein may be, for example, a 5 mass % phosphoric acid or a 3 mass % chromium acid.

Thereafter, the aluminum base 18 is again partially anodized such that the minute recessed portions 12 are grown in the depth direction while the thickness of the porous alumina layer 10 is increased as shown in FIG. 2(e). Here, the growth of the minute recessed portions 12 starts at the bottom of the previously-formed minute recessed portions 12, so that the lateral surface of the minute recessed portions 12 generally has a stepped shape.

Thereafter, when necessary, the porous alumina layer 10 is brought into contact with an etchant of alumina to be further etched such that the diameter of the minute recessed portions 12 is further increased as shown in FIG. 2(f). The etchant used in this step may preferably be the above-described etchant. The same etching bath may be used.

The series of the above processes is preferably ended with the anodization step. When the etching step of FIG. 2(f) is performed, it is preferred that the anodization step is performed one more time. By ending the process with the anodization step (without performing any subsequent etching step), the size of the bottom portion of the minute recessed portions 12 can be decreased. Thus, in a moth-eye structure which is formed using a resultant moth-eye mold, the raised portions can have small tips, so that the antireflection effects can be improved. As a matter of course, the number of cycles through which the anodization and the etching are repeated and the respective conditions (including the durations) may by varied. These parameters may be appropriately varied according to a desired moth-eye structure (the antireflection function or the like).

In this way, by repeating the above-described anodization step (FIG. 2(c)) and etching step (FIG. 2(d)), a porous alumina layer 10 is obtained which has uniformly-distributed minute recessed portions 12 that have a desired shape. By repeating the anodization step and the etching step, the minute recessed portions 12 can be conical recessed portions. By appropriately determining the conditions for each of the anodization steps and the etching steps, the size and depth of the minute recessed portions 12 as well as the stepped shape of the lateral surface of the minute recessed portions 12 can be controlled.

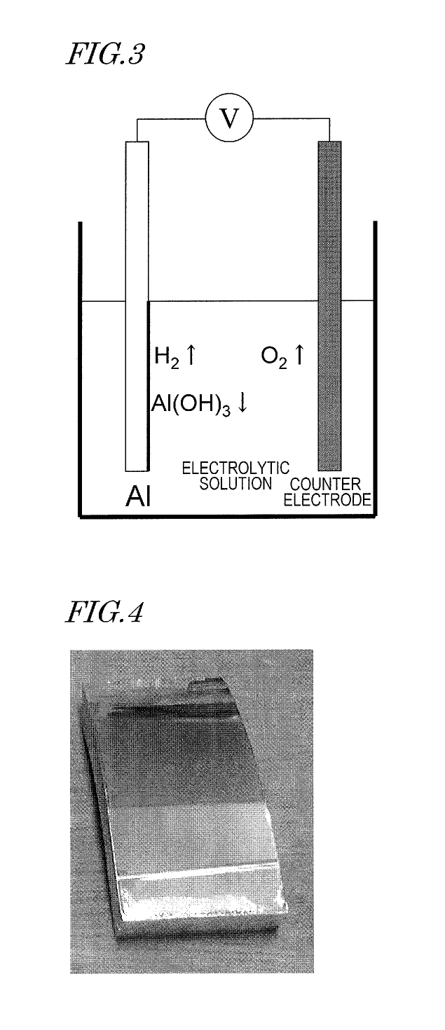

Here, the cathode electrolysis is described with reference to FIG. 3.

The cathode electrolysis refers to passage of an electric current between a surface of an aluminum base and a counter electrode in an aqueous solution as an electrolytic solution, with the surface of the aluminum base being a cathode, as shown in FIG. 3. The aqueous solution used may be an electrolytic solution which is prepared for anodization or may be water whose resistance value is not more than 1 M.

The reaction which occurs in the electrolytic solution when the cathode is made of Al is expressed by Formula (1) shown below.

2Al+6H₂O→2Al(OH)₃↓+3H₂↑ (1)

When an voltage is applied with the cathode made of Al, the total reaction at the cathode includes production of hydrogen and formation of an aluminum hydroxide film over the surface of the aluminum base. Hereinafter, detailed steps of the reaction are described.

At the cathode, an electron donating/receiving reaction expressed by Formula (2) shown below occurs.

Al→Al³⁺+3e⁻ (2)

Also, an electrolytic dissociation of water which is expressed by Formula (3) shown below occurs.

2H₂O [symbol] H₃O⁺+OH⁻ (3)

Also, H₃O⁺ in the aqueous solution receives an electron as expressed by Formula (4) shown below.

2H₃O⁺+2e⁻→H₂↑+2H₂O (4)

When the reaction of Formula (4) occurs, Formula (3) loses its equilibrium so that OH⁻ is locally excessive near the cathode.

As a result, Formula (5) shown below loses its equilibrium so that Al in the surface of the aluminum base reduces.

Al³⁺+3OH⁻ [symbol] Al(OH)₃ (5)

When discussing the reaction velocity, it is necessary to consider the electrolyte. When the aqueous solution is an acidic electrolytic solution (the acid is expressed as HA where H means hydrogen), acid HA dissociates as expressed by Formula (6).

HA+H₂O [symbol] H₃O⁺+A⁻ (6)

As a result of the reaction expressed by Formula (4) shown above, hydrogen is produced (i.e., released from the aqueous solution), so that excessive OH⁻ in the aqueous solution and H₃O⁺ of Formula (6) cause a reaction as expressed by Formula (7) shown below.

H₃O⁺+OH⁻ [symbol] 2H₂O (7)

It is inferred from Formula (2) that the velocity of Formula (5) is proportional to the current density. It is also inferred from Formula (6) and Formula (7) that the velocity of Formula (5) is inversely proportional to the concentration of the electrolytic solution.

In the acidic electrolytic solution, the aluminum hydroxide produced in Formula (5) dissolves as expressed by Formula (8) shown below.

Al(OH)₃+3HA [symbol] Al³⁺+3A⁻+3H₂O (8)

Whether or not the aluminum hydroxide remains in the form of a film depends on the balance of the reaction velocities of Formula (8) and Formula (5) and the surface temperature of the cathode (aluminum base) at the time of formation of the film.

As described above, when the surface of the aluminum base undergoes the cathode electrolysis, aluminum dissolves out from the surface of the aluminum base, so that a minute uneven structure is formed in the surface (see FIG. 2(b)). By anodizing the surface in which this minute uneven structure has been formed, a porous alumina layer is formed which has uniformly-distributed minute recessed portions as described above without being affected by the damaged layer. The “uniform distribution” refers to a condition where the two-dimensional distribution of the minute recessed portions does not have a macroscopic nonuniformity such as described previously with reference to FIG. 8(b). This has no relationship with the regularity or irregularity in the two-dimensional distribution of the minute recessed portions. By performing the anodization after the cathode electrolysis, minute recessed portions whose two-dimensional distribution does not have regularity can be formed uniformly over a surface of the aluminum base which has a damaged layer.

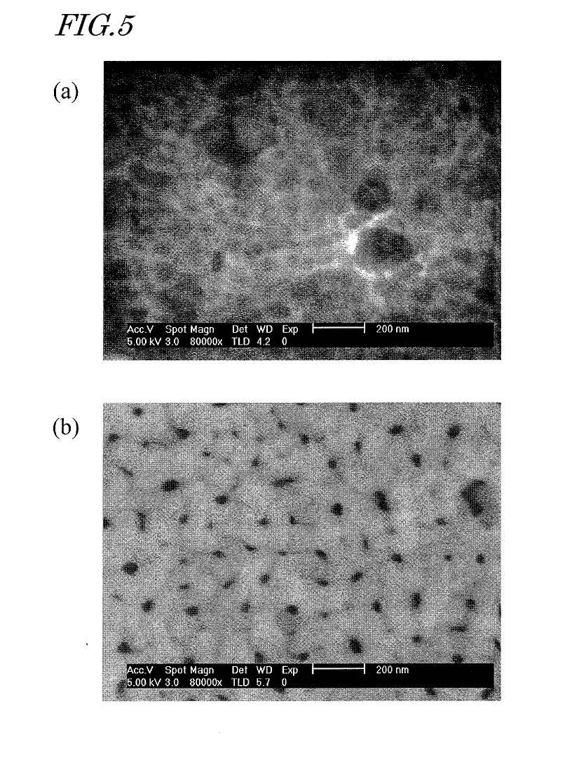

FIG. 4 is a photographic image showing a mirror-cut surface of the aluminum base (see FIG. 8(a)) on which cathode electrolysis was performed and thereafter anodization was performed. The cathode electrolysis was specifically realized by performing the following procedure three times: allowing passage of an electric current of 4 A/dm³ for 30 seconds in a 0.1 M oxalic aqueous solution as the electrolytic solution and, then, pulling the aluminum base out of the electrolytic solution. After the cathode electrolysis, to remove the aluminum hydroxide film formed over the surface of the aluminum base, the aluminum base was immersed in a 1 M phosphoric aqueous solution at 30° C. for 10 minutes. Thereafter, anodization was performed in a 0.1 M oxalic aqueous solution at a constant voltage of 60 V for 2 minutes. As clearly seen from comparison with the photographic image shown in FIG. 8(b) which was obtained after the anodization was performed on the mirror-cut surface (as machined) of the aluminum base, no white striped pattern is seen in the surface shown in FIG. 4, which is an evidence that the formed porous alumina layer has uniformly-distributed minute recessed portions.

The mirror-cut surface of the aluminum base which is shown in FIG. 8(a), the surface shown in FIG. 8(b) which was obtained after the anodization was performed on the mirror-cut surface (as machined) of the aluminum base, and the surface obtained after cathode electrolysis and subsequent anodization were performed on the mirror-cut surface of the aluminum base shown in FIG. 4 were observed by means of SEM. The results of the observation are described below.

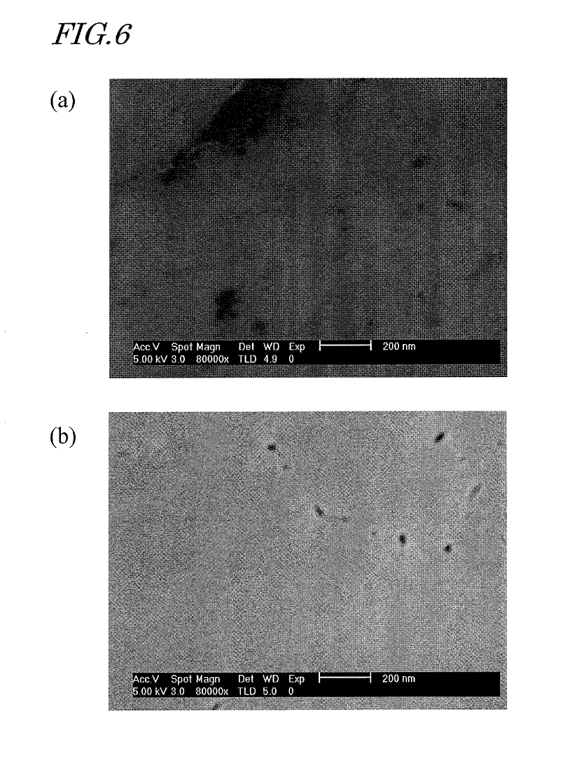

FIG. 5(a) shows a SEM image of a surface obtained by performing the cathode electrolysis on the mirror-cut surface of the aluminum base. FIG. 5(b) shows a SEM image of a surface obtained by further performing the anodization (Inventive Example). On the other hand, FIG. 6(a) shows a SEM image of a mirror-cut surface of the aluminum base. FIG. 6(b) shows a SEM image of a surface obtained after the anodization was performed on the mirror-cut surface of the aluminum base, without undergoing the cathode electrolysis (Comparative Example).

First, FIG. 5(a) is compared with FIG. 6(a). As seen from the SEM image of FIG. 6(a), no uneven structure is seen in the mirror-cut surface of the aluminum base, and the surface is very smooth. On the other hand, as seen from the SEM image of FIG. 5(a), in the mirror-cut surface of the aluminum base on which the cathode electrolysis was performed, the minute uneven structure can be seen.

Next, FIG. 5(b) is compared with FIG. 6(b). As seen from the SEM image of FIG. 6(b), the surface only has a small number of minute recessed portions. This conforms to the above description which has been provided with reference to the SEM image shown in FIG. 8(c) whose magnification is smaller than that of the SEM image of FIG. 6(b). On the other hand, as seen from the SEM image of FIG. 5(b), by performing the anodization after the cathode electrolysis on the surface of the aluminum base, the resultant porous alumina layer has uniformly-distributed minute recessed portions.

As seen from the comparison of FIG. 5(a) and FIG. 5(b), the average neighboring distance of the minute uneven structure formed by the cathode electrolysis (FIG. 5(a)) is smaller than the average neighboring distance of a plurality of minute recessed portions of an intended porous alumina layer. The average neighboring distance of the uneven structure shown in FIG. 5(a) is several tens of nanometers. The average neighboring distance of the minute recessed portions shown in FIG. 5(b) is about 200 nm. This accords with the mechanism of formation of the porous alumina layer which has previously been described with reference to FIG. 9 and FIG. 10. Note that the average neighboring distance may be obtained by means of image analysis of the SEM image. The two-dimensional size of the minute recessed portions may be considered as being equal to the neighboring distance.

The effect of the cathode electrolysis on the anodization is described with reference to FIG. 7. FIG. 7 is a graph showing the variation of a current over time during anodization with a constant voltage. The graph shows the results obtained when the cathode electrolysis was performed on the mirror-cut surface of the aluminum base under three different conditions, Conditions 1 to 3, before the anodization, and the result obtained when only the anodization was performed on the mirror-cut surface, without performing the cathode electrolysis (Condition 4).

Under either of Conditions 1 to 3, the conditions for the cathode electrolysis were that the electrolytic solution was a 0.1 M oxalic aqueous solution, and the temperature of the solution was 20° C.

Condition 1: Allowing passage of a current of 4 A/dm³ for 30 seconds and then pulling the aluminum base out of the electrolytic solution. This procedure was performed 3 times.

Condition 2: Allowing passage of a current of 1.6 A/dm³ for 30 seconds and then pulling the aluminum base out of the electrolytic solution. This procedure was performed 3 times.

Condition 3: Allowing passage of a current of 1.6 A/dm³ for 30 seconds and then pulling the aluminum base out of the electrolytic solution. This procedure was performed 6 times.

The reason why the aluminum base was pulled out of the electrolytic solution such that the cathode electrolysis was separated into multiple times is to prevent bubbles generated on the surface of the aluminum base that is the cathode from inhibiting the reaction so that the progress of the cathode electrolysis would not hindered in some portions of the surface.

After the cathode electrolysis, to remove the aluminum hydroxide film formed over the surface of the aluminum base, the aluminum base was immersed in a 1 M phosphoric aqueous solution at 30° C. for 10 minutes.

Thereafter, the anodization was performed in a 0.1 M oxalic aqueous solution with a constant voltage of 60 V for 2 minutes. The current profile obtained during the anodization is shown in FIG. 7.

In the case of Condition 4 where the cathode electrolysis was not performed, the profile does not include the phases of the above-described Mode III and Mode IV. Thus, it is inferred that generation and growth of minute recessed portions (micropores) did not occur.

In all of the cases of Conditions 1 to 3 where the cathode electrolysis was performed, it is seen that the profiles include the phases of four modes, Modes I, II, III and IV. Thus, it is inferred that a minute uneven structure that had a degree of roughness which may be necessary for the progress of Mode III and Mode IV was formed by the cathode electrolysis.

Comparing Condition 1 and Condition 2 between which the current density used for the cathode electrolysis is different, it is seen that the timing of transition from Mode II to Mode III is earlier in Condition 1 (4 A/dm³). This is probably because of the difference in the degree of the surface roughness (minute uneven structure) produced by the cathode electrolysis. It is therefore inferred that an uneven structure which has a smaller average neighboring distance was formed under Condition 1 where the current density is greater than under Condition 2 (1.6 A/dm³).

Comparing Condition 2 and Condition 3 between which the number of times of the cathode electrolysis is different, the current profiles are generally identical. It is thus inferred that the processes from Mode I through Mode IV progressed with generally identical velocities.

It is not the amount of the cathode electrolysis but the current density that dominantly affects the degree of roughness of the minute uneven structure which is necessary for transition from Mode II to Mode III.

As clearly seen from the descriptions provided above, it was experimentally confirmed that, even when a damaged layer is formed over the surface of the aluminum base, performing the cathode electrolysis to form a minute uneven structure over the surface enables formation of a porous alumina layer which has uniformly-distributed minute recessed portions. As a matter of course, when a damaged layer is entirely removed by performing the cathode electrolysis, a porous alumina layer which has uniformly-distributed minute recessed portions can be formed through the process from Mode I to Mode IV which have been described with reference to FIG. 9 and FIG. 10.

An aluminum base which has a porous alumina layer can be used as a mold without any modification. Therefore, the aluminum base preferably has sufficient rigidity. To obtain an aluminum base in the form of a roll, the aluminum base preferably has excellent processibility. From the viewpoint of rigidity and processibility, it is preferred to use an aluminum base which contains an impurity. It is particularly preferred that the content of an element whose standard electrode potential is higher than Al is not more than 10 ppm and that the content of an element whose standard electrode potential is lower than Al is not less than 0.1 mass %. It is particularly preferred to use an aluminum base which contains Mg as an impurity element. Mg is a base metal relative to Al and has a standard electrode potential of −2.36 V. The content of Mg is preferably not less than 0.1 mass % and not more than 4.0 mass % of the whole. Preferably, it is less than 1.0 mass %. If the content of Mg is less than 0.1 mass %, sufficient rigidity cannot be obtained. The solid solution limit of Mg to Al is 4.0 mass %. The content of the impurity element may be appropriately determined depending on the shape, thickness and size of the aluminum base, according to required rigidity and/or processibility. However, in general, if the content of Mg exceeds 1.0 mass %, the processibility decreases.

When an aluminum base which contains an impurity is used as described above, it is preferred to prevent the above-described abnormal dissolution (abnormal etching) which may occur due to the impurity by using a mold manufacturing method described in WO 2010/073636 of the applicant of the present application. Specifically, it may be prevented by using an etchant which contains an anodic inhibitor, particularly an organic anodic inhibitor (countermeasure a), using an Al base which contains not more than 10 ppm of an element whose standard electrode potential is higher than Al and not less than 0.1 mass % of an element whose standard electrode potential is lower than Al (countermeasure b), or forming an additional barrier layer of alumina before the etching step (countermeasure c). As a matter of course, any two of the above three countermeasures a to c may be employed in combination. Further, the etchant used may contain a compound which can form a coating over aluminum in place of or together with the anodic inhibitor. The entire disclosures of WO 2010/073636 are incorporated by reference in this specification.

The present inventor conducted further researches on the cathode electrolysis and found that, by adjusting the conditions for the cathode electrolysis and/or the duration of the cathode electrolysis, it is possible to form a plurality of recessed portions (also referred to as “first recessed portions”) whose two-dimensional size is greater than a plurality of minute recessed portions for formation of the inverted moth-eye structure which have a two-dimensional size of not less than 10 nm and less than 500 nm (also referred to as “second recessed portions”). The two-dimensional size of the recessed portions formed by the cathode electrolysis is not less than 200 nm and not more than 100 μm. As the minute recessed portions for formation of the inverted moth-eye structure, minute recessed portions whose two-dimensional size is smaller than the recessed portions formed by the cathode electrolysis are formed.

In the prior art, it has been believed that, as described above, the two-dimensional size of the raised portions that form the antiglare structure is preferably not less than 1 μm and less than 100 μm. This is because it has been believed that a high antiglare property which is represented by a haze value of not less than 10 or not less than 20 is preferred. Recently, there is a tendency that clear images are preferred, and there is an increasing need for an antireflection film which has a lower haze value than the prior art antireflection film (for example, 1 to 5). According to the researches conducted by the applicant of the present application, when the two-dimensional size of the raised portions that form the antiglare structure is not less than 200 nm, an antireflection film which has a low haze value can be obtained (PCT/JP2010/069095). The entire disclosures of PCT/JP2010/069095 are incorporated by reference in this specification. Note that the haze value refers to a percentage value of the ratio of the diffused transmission light to the total transmission light (the sum of the straight transmission light and the diffused transmission light) under the condition that a sample was irradiated with collimated light. Here, the measurement was carried out using Integrating Sphere Haze Meter NDH-2000 manufactured by NIPPON DENSHOKU INDUSTRIES CO., LTD.

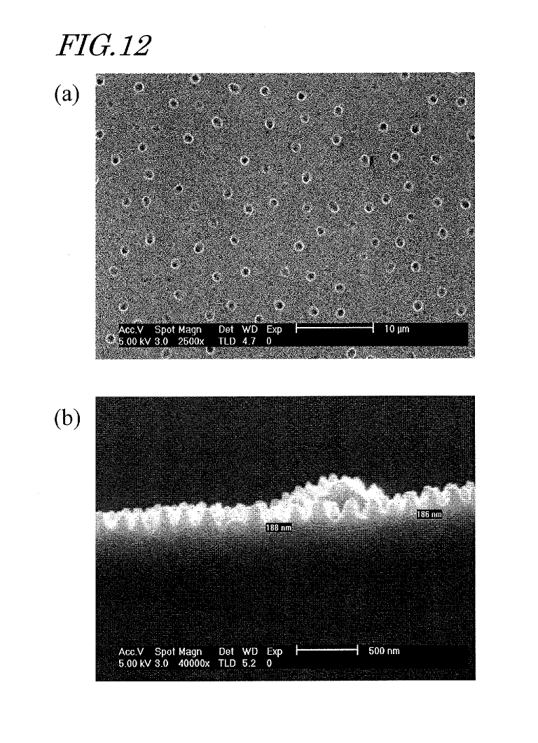

A method for manufacturing a mold of this embodiment of the present invention is described with reference to FIGS. 11(a) to 11(c).

First, an aluminum base 18 is provided as shown in FIG. 11(a). The aluminum base 18 may have a damaged layer. Alternatively, instead of the aluminum base 18, an aluminum film (about 0.5 μm to 5 μm thick) supported on a base, such as a glass substrate, for example, may be used.

Then, an electric current is allowed to pass between a surface of the aluminum base or the aluminum film and a counter electrode in an aqueous solution with the surface being a cathode, whereby a plurality of recessed portions (first recessed portions) 18h whose two-dimensional size viewed in a direction normal to the surface is not less than 200 nm and not more than 100 μm are formed as shown in FIG. 11(b). The aqueous solution (electrolytic solution) may be an electrolytic solution which is prepared for anodization or may be water whose resistance value is not more than 1 M as in the above-described cathode electrolysis. The solution temperature is not limited to any particular value. By adjusting the duration of the cathode electrolysis with the electric current being in the range of about 1 to 100 A/dm³, for example, recessed portions 18h whose two-dimensional size is not less than 200 nm and not more than 100 μm can be formed.

It has not been reported that recessed portions of such a size can be formed by cathode electrolysis of aluminum. The present inventor is the first finder of this phenomenon, but the mechanism has not been clarified yet. By adjusting the conditions for the cathode electrolysis, a minute uneven structure whose two-dimensional size is about several tens of nanometers can be formed as described above, or the recessed portions 18h whose two-dimensional size is not less than 200 nm and not more than 100 μm can also be formed as will be described later with experimental examples. The average neighboring distance of the recessed portions 18h may vary depending on the conditions for the cathode electrolysis. However, the average neighboring distance of the recessed portions 18h is preferably not less than 0.5 μm and not more than 100 μm.

Then, the surface is anodized, whereby a porous alumina layer 10A that has a plurality of minute recessed portions (second recessed portions) 12 whose two-dimensional size viewed in a direction normal to the surface is not less than 10 nm and less than 500 nm is formed over the inner surfaces of the plurality of recessed portions 18h and between the plurality of recessed portions 18h as shown in FIG. 11(c). Thereafter, the porous alumina layer 10A is brought into contact with an etchant, whereby the plurality of minute recessed portions 12 of the porous alumina layer 10A are enlarged. As described above, by alternately repeating the anodization step and the etching step through a plurality of cycles, the porous alumina layer 10A that has the minute recessed portions 12 which have a desired cross-sectional shape can be formed. The openings of the minute recessed portions 12 are preferably enlarged by etching (so as to have a generally conical cross-sectional shape) such that the two-dimensional size (diameter) of the minute recessed portions 12 is generally equal to the neighboring distance, for example, not less than 10 nm and less than 500 nm.

Since the minute recessed portions 12 are formed so as to be superposed over the recessed portions 18h whose two-dimensional size is not less than 200 nm and not more than 100 μm, a mold 100A for production of an antireflection film in which the moth-eye structure is superposed over the antiglare structure is obtained. Note that, in FIG. 11(c), recessed portions formed in the porous alumina layer 10A are shown as recessed portions 12h due to the reflection of the recessed portions 18h formed by the cathode electrolysis.

When the cathode electrolysis is performed, a film of aluminum hydroxide may be formed over the surface of the aluminum base as described above. After the cathode electrolysis and before the anodization, as necessary, the aluminum hydroxide film formed over the surface of the aluminum base is removed. Aluminum hydroxide can be removed by immersion into a 1M phosphoric acid aqueous solution at 30° C., for example, for 10 minutes as described above.

FIG. 12(a) is a SEM image of a surface of a mold which was obtained according to the above-described manufacturing method. This mold was manufactured according to the following method.

An aluminum base which would not undergo abnormal dissolution during the etching (e.g., base aluminum with the purity of 99.99 mass % or higher which contains about 0.7 mass % Mg) was used, and an electric current (current value: A/dm³) was allowed to pass for 10 minutes between a surface of the aluminum base and a counter electrode in a 0.05 M oxalic acid aqueous solution (solution temperature: 20° C.) with the surface being a cathode. As a result, recessed portions (recessed portions 18h in FIG. 11(a)) whose diameter (two-dimensional size) viewed in a direction normal to the surface of the aluminum base was 500 nm to 2 μm (about μm on average) were formed with the average neighboring distance of about 5 μm. In the SEM image shown in FIG. 12(a), each of these recessed portions is observed as a generally circular region with a white rim.

Thereafter, a porous alumina layer was formed by applying a constant voltage at 60 V for 40 seconds in a 0.1 M oxalic acid aqueous solution where the aluminum base serves as an anode. Then, wet etching was performed for 30 minutes using 5 mass % phosphoric acid at 50° C. Thereafter, again, the anodization step and the wet etching step were alternately repeated under the above-described conditions through four cycles, and this process was ended with the anodization. As a result, minute recessed portions whose two-dimensional size (average neighboring distance) was about 150 nm and whose cross-sectional shape was conical (recessed portions 12 of FIG. 11(c)) were formed. In the SEM image shown in FIG. 12(b), these minute recessed portions are observed as small dots.

Thus, the mold manufacturing method of this embodiment of the present invention can provide an improved manufacturing efficiency as compared with the prior art because the mold 100A that is for production of an antireflection film in which a moth-eye structure is superposed over an antiglare structure can be obtained only by performing the cathode electrolysis step before the anodization step for formation of an inverted moth-eye structure.

This mold manufacturing method includes the step of performing the cathode electrolysis on an aluminum surface and is therefore capable of uniformly processing even a machined surface of an aluminum base as described above. By forming an inverted moth-eye structure after the cathode electrolysis of the machined surface, a porous alumina layer for production of an antireflection film in which a moth-eye structure is superposed over an antiglare structure can be formed over the machined surface of the aluminum base. Thus, this mold manufacturing method is preferably used in manufacture of a mold in the form of a roll.

An antireflection film can be produced using a moth-eye mold which has the surface shown in FIG. 12(a), for example, as described below.

An UV-curable resin provided between a surface of a work and a moth-eye mold is irradiated with ultraviolet (UV) light through the moth-eye mold such that the UV-curable resin is cured. The UV-curable resin may be provided over the surface of the work or may be provided over a mold surface of the moth-eye mold (a surface of the mold which has the moth-eye structure). The UV-curable resin used may be, for example, an acrylic resin.

Thereafter, the moth-eye mold is separated from the work, whereby a resin layer is formed over the surface of the work such that the resin layer has a structure that is inverse of the uneven structure of the moth-eye mold. In this way, an antireflection film is obtained that has a structure over which raised portions whose two-dimensional size viewed in a direction normal to the surface not less than 200 nm and not more than 100 μm (herein, from 500 nm to 2 μm (about 1 μm on average)) and raised portions whose two-dimensional size is not less than 10 nm and less than 500 nm (herein, about 150 nm) are superposed. In this way, an antireflection film is obtained which has a structure wherein a moth-eye structure is superposed over an uneven structure that provides an antiglare function. The haze value of the antireflection film obtained herein was 13.46, and the surface reflectance was 0.3%.

### INDUSTRIAL APPLICABILITY

A mold manufacturing method and a mold of the present invention are particularly preferably used in a method for manufacturing a moth-eye mold in the form of a roll. A moth-eye mold of the present invention is preferably used in formation of an antireflection structure.

### REFERENCE SIGNS LIST

10, 10A porous alumina layer
12 minute recessed portions (micropores)
18 aluminum base
18a damaged layer
18b main base body
18h recessed portions
100A mold

1. A method for manufacturing a mold, comprising the steps of:
(a) providing an aluminum base or an aluminum film;
(b) allowing passage of an electric current between a surface of the aluminum base or the aluminum film and a counter electrode in an aqueous solution with the surface being a cathode, thereby forming a plurality of first recessed portions whose two-dimensional size viewed in a direction normal to the surface is not less than 200 nm and not more than 100 μm;
(c) after step (b), anodizing the surface, thereby foi wing a porous alumina layer which has a plurality of second recessed portions whose two-dimensional size viewed in a direction normal to the surface is not less than 10 nm and less than 500 nm over an inner surface of the plurality of first recessed portions and between the plurality of first recessed portions; and
(d) after step (c), bringing the porous alumina layer into contact with an etchant, thereby enlarging the plurality of second recessed portions of the porous alumina layer.

2. The method of claim 1, wherein
step (a) includes providing an aluminum base which has a machined surface, and
step (b) includes allowing passage of an electric current between the machined surface and the counter electrode with the machined surface being a cathode.

3. The method of claim 1, wherein the aluminum base is in the form of a roll.

4. The method of claim 1, wherein an average neighboring distance of the plurality of first recessed portions is not less than 0.5 μm and not more than 100 μm.

5. A mold which is manufactured according to the manufacturing method as set forth in claim 1.

6. An antireflection film which is produced using the mold as set forth in claim 5.
